(19) United States
(12) Patent Application Publication
(10) Pub. No.: US 2020/0240438 A1
(43) Pub. Date: Jul. 30, 2020

(54) FAN

(71) Applicant: NIDEC CORPORATION, Kyoto (JP)

(72) Inventors: QIANG MA, Dalian (CN); Toshifumi FUKUI, Dalian (CN); Fengwen YANG, Dalian (CN)

(73) Assignee: NIDEC CORPORATION, Kyoto (JP)

(21) Appl. No.: 16/739,090

(22) Filed: Jan. 9, 2020

(30) Foreign Application Priority Data
Jan. 30, 2019 (CN) 201920169202.7

(51) Int. Cl. F04D 29/60; F04D 29/66; F16B 7/04; F16B 21/09; F04D 29/64; F04D 29/26

(52) U.S. Cl. CPC F04D 29/603; F04D 29/661; F04D 29/263; F16B 21/09; F04D 29/646; F16B 7/0406

(57) ABSTRACT

A fan includes: an impeller, rotating around a rotation axis; a motor, disposed on an axial side of the impeller; and a supporting component, disposed on an axial side of the motor. The supporting component includes: a base, disposed on the axial side of the motor; first connection portions, extending from a partial area of a side wall of the base to a radial outer side; and mounting portions, disposed on an end portion on the radial outer side of the first connection portion and closer to the radial outer side than the impeller. The mounting portion has first and second claw portions arranged along a circumferential direction. An opening portion for inserting a vibration-proof component is between end portions of the first and second claw portions. A first gap on the radial outer side of the opening portion is greater than a second gap on a radial inner side.

### CROSS-REFERENCE TO RELATED APPLICATION

The present invention claims priority under 35 U.S.C. § 119 to Chinese Application No. 201920169202.7 filed on Jan. 30, 2019 the entire content of which is incorporated herein by reference.

### BACKGROUND

### Technical Field

The disclosure relates to an air supply technology, and in particular, to a fan.

### Description of Related Art

In the related art, a fan usually includes a motor and an impeller that is driven by the motor to rotate. To reduce fan noises and improve fan stability, a vibration-proof component is usually disposed in the fan.

It should be noted that the above description of the technical background is only intended to help clearly and completely describe technical solutions of the disclosure, and is provided to facilitate understanding of a person skilled in the art. The above technical solutions should not be considered to be known to a person skilled in the art because these solutions are described in the background part of the disclosure.

The inventors found that, in the related art, it is difficult to mount a vibration-proof component into a mounting portion because one end of an opening of the mounting portion is parallel with the other end, and a distance between one end of the mounting portion and the other end is less than an outer diameter of the vibration-proof component, and consequently, the mounting operation requires more working hours.

### SUMMARY

According to an embodiment of the disclosure, a fan is provided, including: an impeller, rotating with a rotation axis as a center; a motor, disposed on an axial side of the impeller to drive the impeller to rotate; and a supporting component, disposed on an axial side of the motor to support the motor. The supporting component includes: a base; a plurality of first connection portions, extending from a partial area of a side wall of the base to a radial outer side; and a plurality of mounting portions, disposed on an end portion on the radial outer side of the first connection portion and configured in a position closer to the radial outer side than the impeller. The mounting portion has a first claw portion and a second claw portion arranged along a circumferential direction. An opening portion into which a vibration-proof component is inserted is provided between an end portion of the first claw portion and an end portion of the second claw portion, and a first gap on the radial outer side of the opening portion is greater than a second gap on a radial inner side of the opening portion.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic diagram of a fan according to Embodiment 1 of the disclosure.

FIG. 2 is a top view of the fan according to Embodiment 1 of the disclosure.

FIG. 3 is a schematic diagram of a supporting component according to Embodiment 1 of the disclosure.

FIG. 4 is a schematic diagram of a mounting portion according to Embodiment 1 of the disclosure.

FIG. 5 is another schematic diagram of the mounting portion according to Embodiment 1 of the disclosure.

FIG. 6 is another schematic diagram of the mounting portion according to Embodiment 1 of the disclosure.

FIG. 7 is another schematic diagram of the mounting portion according to Embodiment 1 of the disclosure.

FIG. 8 is another schematic diagram of the mounting portion according to Embodiment 1 of the disclosure.

FIG. 9 is another schematic diagram of the mounting portion according to Embodiment 1 of the disclosure.

FIG. 10 is a cross-sectional view of the fan according to Embodiment 1 of the disclosure.

FIG. 11 is a schematic diagram of a vibration-proof component according to Embodiment 1 of the disclosure.

FIG. 12 is a top view of the vibration-proof component according to Embodiment 1 of the disclosure.

### DESCRIPTION OF THE EMBODIMENTS

With reference to the accompanying drawings, through the following specification, the foregoing and other features of the disclosure are more apparent. In this specification and the accompanying drawings, specific implementations of the disclosure are disclosed in detail, and some implementations that can use the principle of the disclosure are indicated. It should be understood that the disclosure is not limited to the described implementations; on the contrary, the disclosure includes all modifications, variants and equivalents that fall within the scope of the appended claims.

In the embodiments of the disclosure, terms such as “first” and “second” are used to distinguish different elements in terms of names, and are not used to indicate a spatial arrangement or a time sequence of these elements, and these elements should not be limited by these terms. The term “and/or” includes any and all combinations of one or more of listed associated terms. Terms such as “comprise”, “include” and “have” refer to the existence of the described features, elements, devices or components, but do not exclude the existence or addition of one or more other features, elements, devices or components.

In the embodiments of the disclosure, singular forms such as “a/an” and “the” include plural forms and should be understood in a broad sense as a meaning of “a type” or “a kind” instead of “one”. In addition, the term “the” should be understood as including both a singular form and a plural form, unless otherwise clearly stated in the context. In addition, the term “according to” should be understood as “at least partially according to . . . ”, and the term “based on” should be understood as “at least partially based on . . . ”, unless otherwise clearly stated in the context.

In the embodiments of the disclosure, a direction parallel to a direction extending along a central axis of a fan or a vibration-proof component is referred to as “an axial direction”, a direction of a radius with the central axis as a center is referred to as “a radial direction”, and a direction around the central axis is referred to as “a circumferential direction”. It should be noted that the definitions of the directions in this specification are only for ease of description of the embodiments of the disclosure, and are not intended to limit directions of the fan or the vibration-proof component during manufacturing and in use.

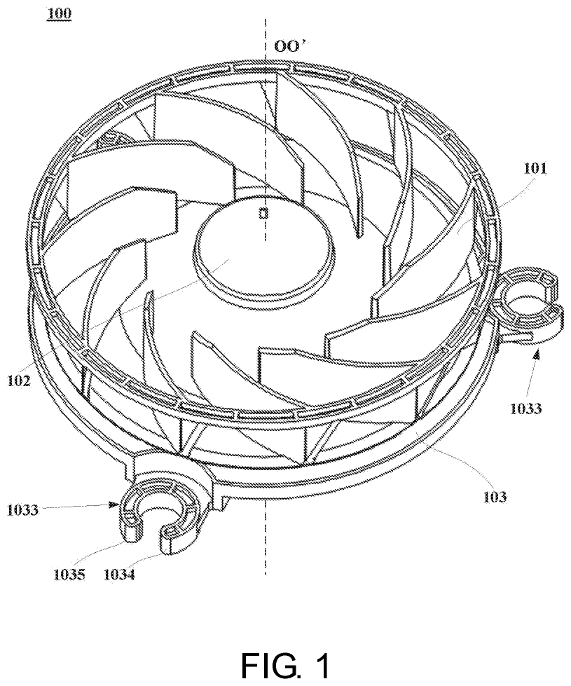

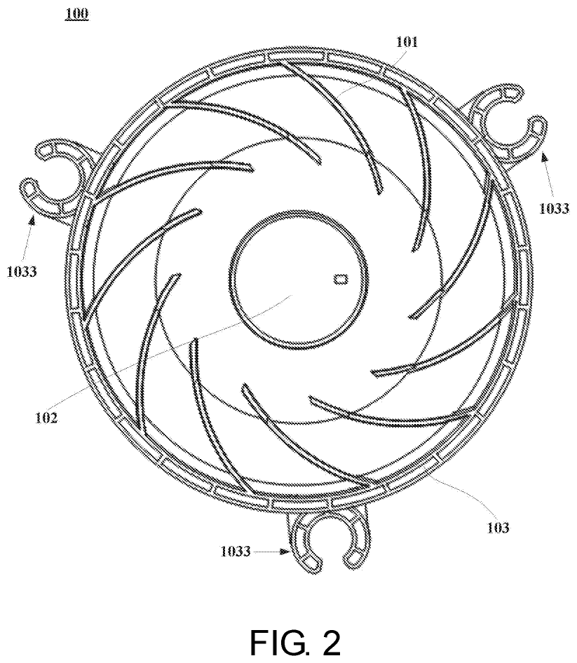

Embodiment 1 of the disclosure provides a fan. FIG. 1 is a schematic diagram of the fan 100 according to Embodiment 1 of the disclosure. FIG. 2 is a top view of the fan 100 according to Embodiment 1 of the disclosure.

In the present embodiment, as shown in FIG. 1 and FIG. 2, the fan 100 may include an impeller 101, a motor 102 and a supporting component 103. The impeller 101 rotates with a rotation axis OO′ as a center. The motor 102 is disposed on an axial side (the lower side shown in FIG. 1) of the impeller 101 to drive the impeller 101 to rotate. The supporting component 103 is disposed on an axial side of the motor 102 to support the motor 102.

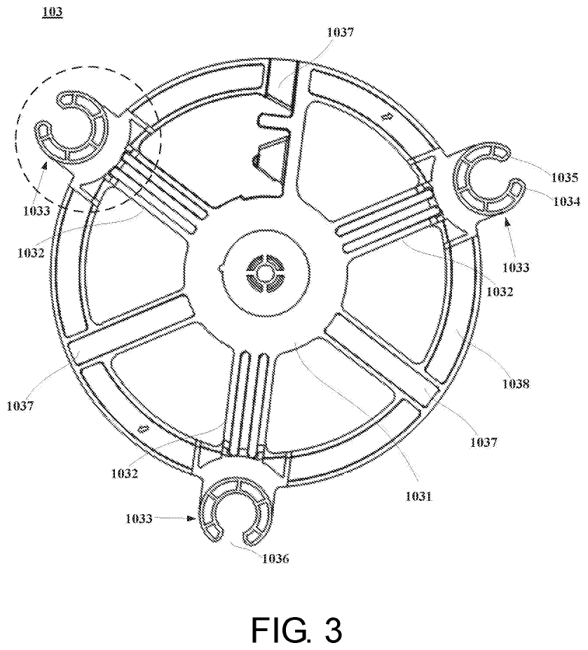

FIG. 3 is a schematic diagram of the supporting component 103 according to Embodiment 1 of the disclosure. As shown in FIG. 3, the supporting component 103 includes a base 1031, a plurality of first connection portions 1032, and a plurality of mounting portions 1033. The plurality of first connection portions 1032 extend from a partial area of a side wall of the base 1031 to a radial outer side. The mounting portion 1033 is disposed on an end portion on the radial outer side of the first connection portion 1032. As shown in FIG. 2, the mounting portion 1033 is configured in a position closer to the radial outer side than the impeller 101. The mounting portion 1033 has a first claw portion 1034 and a second claw portion 1035 arranged along the circumferential direction. An opening portion 1036 into which a vibration-proof component is inserted is provided between an end portion of the first claw portion 1034 and an end portion of the second claw portion 1035.

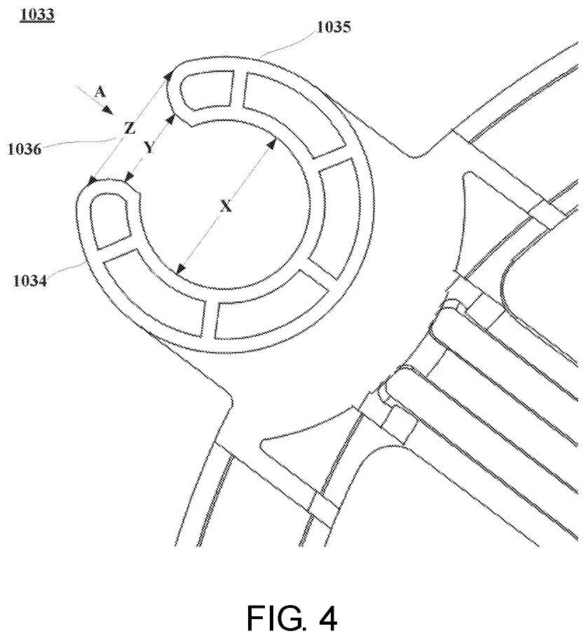

FIG. 4 is a schematic diagram (corresponding to a part shown by a dashed-line circle in FIG. 3) of the mounting portion 1033 according to Embodiment 1 of the disclosure. As shown in FIG. 4, a first gap Z on a radial outer side of the opening portion 1036 is greater than a second gap Y on a radial inner side of the opening portion 1036.

In the present embodiment, the first gap Z on the radial outer side of the opening portion 1036 of the mounting portion 1033 is made greater than the second gap Y on the radial inner side of the opening portion 1036, so that the vibration-proof component can be easily mounted into the mounting portion 1033 through the opening portion 1036, and further working hours of the operation of mounting the vibration-proof component can be reduced, thereby helping improve production efficiency.

In the present embodiment, the motor 102 may be any type of motor and, for example, the motor 102 may be a direct current motor or an alternating current motor, or may be a squirrel-cage induction motor or a wound-rotor induction motor. The disclosure is not intended to limit the motor 102 to a certain type.

In the present embodiment, the base 1031 of the supporting component 103 may be configured to support the motor 102, and the base 1031 may be disposed opposite to the motor 102 in the axial direction.

In the present embodiment, the supporting component 103 may be provided with a plurality of first connection portions 1032 and a plurality of mounting portions 1033. In FIG. 3, three first connection portions 1032 and three mounting portions 1033 are used as an example to illustrate the structure of the supporting component 103. However, the disclosure is not limited thereto, and a quantity of the first connection portions 1032 or the mounting portions 1033 may be 2, or may be 4 or more.

In the present embodiment, as shown in FIG. 3, the plurality of first connection portions 1032 may be disposed at equal intervals along the circumferential direction. This helps improve the balance of the supporting component 103 in the circumferential direction. In addition, because the plurality of mounting portions 1033 are also disposed at equal intervals in the circumferential direction, vibration-proof components can be disposed at equal intervals in the circumferential direction of the fan, thereby helping improve overall vibration-proof performance of the fan. However, the disclosure is not limited thereto. The plurality of first connection portions 1032 may alternatively be disposed at non-equal intervals along the circumferential direction, so that the first connection portions 1032, the mounting portions 1033, and the vibration-proof components can be more flexibly disposed.

In the present embodiment, a gap of the opening portion 1036 is generally increased along the radial direction from a second position in which the second gap Y is located to a first position in which the first gap Z is located. For example, the gap may be gradually increased. However, the disclosure is not limited thereto. The gap may alternatively be increased in some positions in an area from the second position to the first position, and be decreased in some positions or remain unchanged, provided that the gap of the opening portion 1036 is generally increased as a whole in the area from the second position to the first position.

In the present embodiment, as shown in FIG. 4, for the opening portion 1036, the gap of the opening portion 1036 is set to be gradually increased along the radial direction from the second position in which the second gap Y is located to the first position in which the first gap Z is located, wherein the first position is a radially outermost position of the opening portion 1036, and the second position is an intermediate position between a radially innermost position and the radially outermost position of the opening portion 1036.

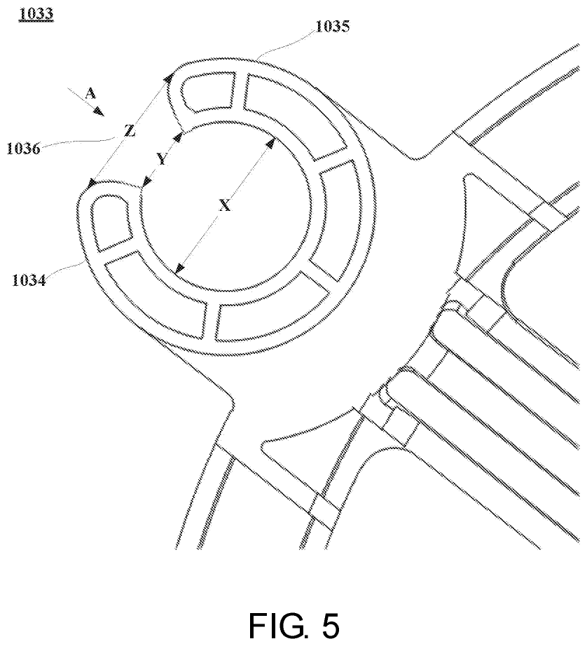

FIG. 5 is another schematic diagram of the mounting portion 1033 according to Embodiment 1 of the disclosure. As shown in FIG. 5, the first position in which the first gap Z is located is the radially outermost position of the opening portion 1036, and the second position in which the second gap Y is located is the radially innermost position of the opening portion 1036. The gap of the opening portion 1036 is set to be gradually increased along the radial direction from the second position in which the second gap Y is located to the first position in which the first gap Z is located.

With the above structure, when the vibration-proof component is mounted into the mounting portion 103 along a direction shown by the arrow A in FIG. 4 and FIG. 5 through the opening portion 1036, because the first gap Z of the opening portion 1036 is greater than the second gap Y, the opening portion 1036 can guide the vibration-proof component to move into the mounting portion 103 from the first position in which the first gap Z is located to the second position in which the second gap Y is located, so that the vibration-proof component can be easily mounted into the mounting portion 103.

In the present embodiment, the end portion of the first claw portion 1034 and the end portion of the second claw portion 1035 are in an arc shape, a polygonal shape, a slash shape, a shape combining an arc shape with a polygonal shape, or a shape combining an arc shape with a straight line.

For example, as shown in FIG. 4, the end portion of the first claw portion 1034 and the end portion of the second claw portion 1035 are in the shape combining an arc shape with a straight line. For example, the end portion of the first claw portion 1034 and the end portion of the second claw portion 1035 are in the arc shape from the first position in which the first gap Z is located to the second position in which the second gap Y is located, and the end portion of the first claw portion 1034 and the end portion of the second claw portion 1035 are in a straight-line shape from the second position in which the second gap Y is located to the radially innermost position of the opening portion 1036. As shown in FIG. 5, the end portion of the first claw portion 1034 and the end portion of the second claw portion 1035 are also in the shape combining an arc shape with a straight line.

FIG. 6 is another schematic diagram of the mounting portion 1033 according to Embodiment 1 of the disclosure. As shown in FIG. 6, the end portion of the first claw portion 1034 and the end portion of the second claw portion 1035 are in the slash shape.

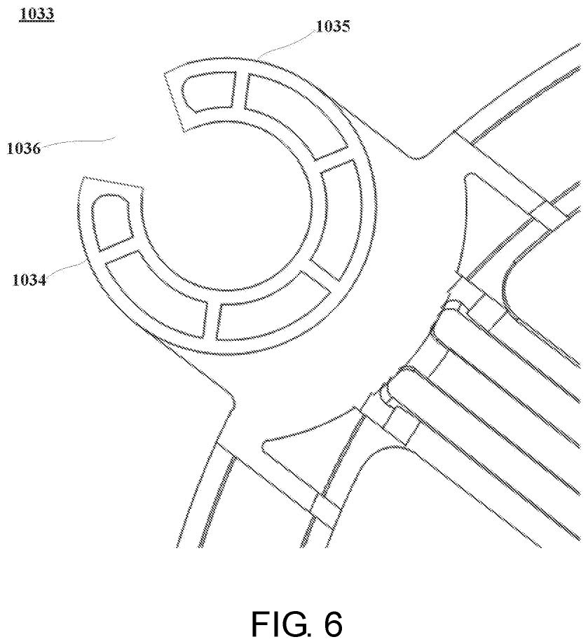

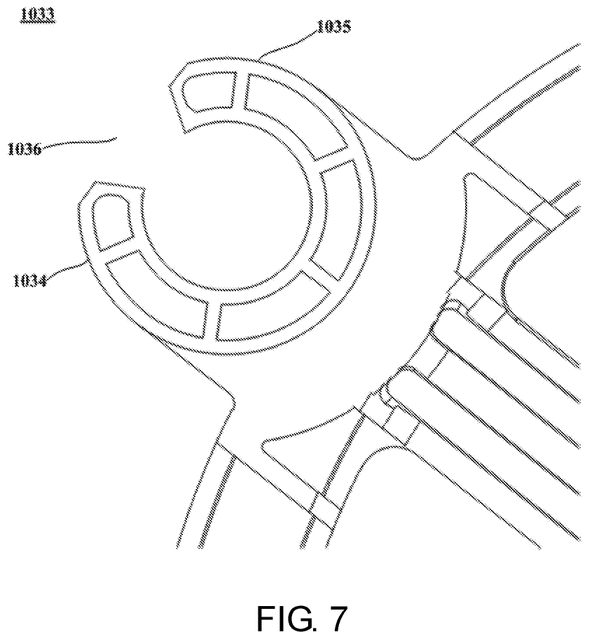

FIG. 7 is another schematic diagram of the mounting portion 1033 according to Embodiment 1 of the disclosure. As shown in FIG. 7, the end portion of the first claw portion 1034 and the end portion of the second claw portion 1035 are in the polygonal shape.

FIG. 8 is another schematic diagram of the mounting portion 1033 according to Embodiment 1 of the disclosure. As shown in FIG. 8, the end portion of the first claw portion 1034 and the end portion of the second claw portion 1035 are in the arc shape.

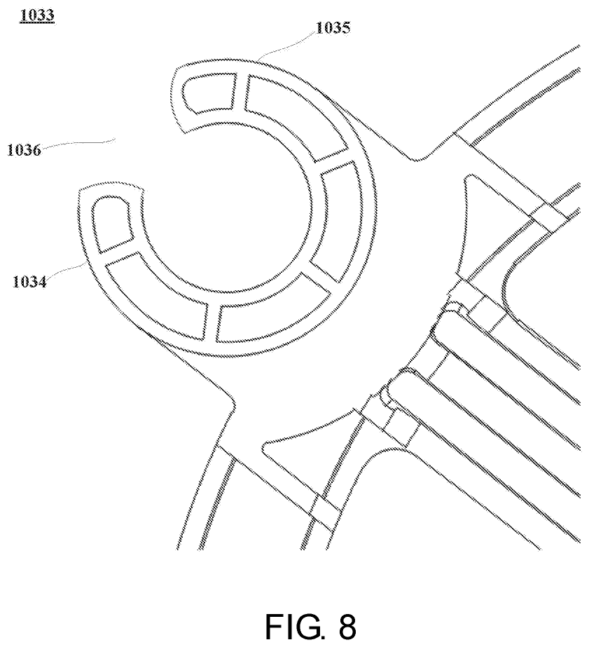

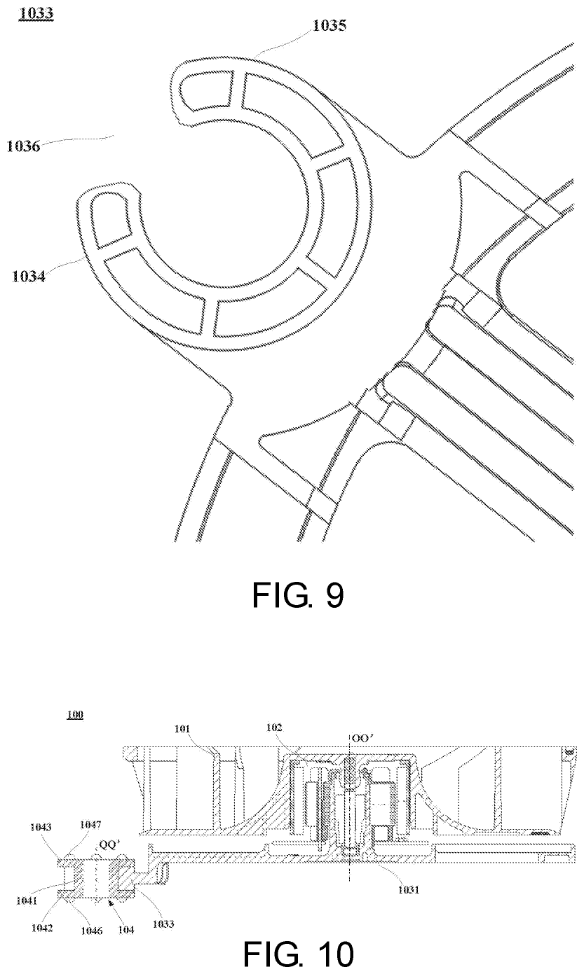

FIG. 9 is another schematic diagram of the mounting portion 1033 according to Embodiment 1 of the disclosure. As shown in FIG. 9, the end portion of the first claw portion 1034 and the end portion of the second claw portion 1035 are in the shape combining an arc shape with a polygonal shape.

In the present embodiment, as shown in FIG. 4 to FIG. 9, the end portion of the first claw portion 1034 and the end portion of the second claw portion 1035 may be in a shape that is symmetric relative to the radial direction. In this way, in a process of mounting the vibration-proof component, the first claw portion 1034 and the second claw portion 1035 can apply symmetric forces on the vibration-proof component, thereby further improving convenience in the operation of mounting the vibration-proof component. However, the disclosure is not limited thereto. The end portion of the first claw portion 1034 and the end portion of the second claw portion 1035 may alternatively be in a shape that is asymmetric relative to the radial direction. In this way, the first claw portion 1034 and the second claw portion 1035 can be more flexibly disposed.

FIG. 4 to FIG. 9 merely exemplarily show the shape of the end portion of the first claw portion 1034 and the end portion of the second claw portion 1035. However, the disclosure is not limited thereto. The end portion of the first claw portion 1034 and the end portion of the second claw portion 1035 may alternatively be in other shapes provided that the shape of the end portion of the first claw portion 1034 and the end portion of the second claw portion 1035 can make the gap on the radial outer side of the opening portion 1036 greater than the gap on the radial inner side of the opening portion 1036.

In the present embodiment, a maximum inner diameter X of the mounting portion 1033 may be equal to or greater than a minimum gap (for example, the second gap Y shown in FIG. 4 and FIG. 5) of the opening portion 1036 by greater than one time, and less than or equal to five times. In other words, the maximum inner diameter X of the mounting portion 1033 is n times the minimum gap of the opening portion 1036, where 1≤n≤5. Setting the foregoing multiple relationship allows the vibration-proof component to be easily mounted into the mounting portion 1033 through the opening portion 1036. However, the disclosure is not limited thereto. The multiple relationship between the maximum inner diameter of the mounting portion 1033 and the minimum gap of the opening portion 1036 may alternatively be set to other values.

In the present embodiment, the maximum gap (for example, the first gap Z shown in FIG. 4 and FIG. 5) of the opening portion 1036 may be greater than the minimum gap (for example, the second gap Y shown in FIG. 4 and FIG. 5) of the opening portion 1036 by greater than one time, and less than or equal to three times. In other words, the maximum gap of the opening portion 1036 is m times the minimum gap of the opening portion 1036, where 1<m≤3. Setting the foregoing multiple relationship can enable the opening portion 1036 to effectively guide the vibration-proof component, so that the vibration-proof component can be easily mounted into the mounting portion 1033 through the opening portion 1036. However, the disclosure is not limited thereto. The multiple relationship between the maximum gap and the minimum gap of the opening portion 1036 may alternatively be set to other values.

In the present embodiment, as shown in FIG. 3, the supporting component 103 may further include: a plurality of second connection portions 1037, extending from the partial area of the side wall of the base 1031 to the radial outer side, wherein the plurality of first connection portions 1032 and the plurality of second connection portions 1037 are disposed at equal intervals along the circumferential direction. Therefore, strength of the supporting component 103 can be improved, and the balance of the supporting component 103 in the circumferential direction can be improved.

In the present embodiment, the supporting component 103 may include the plurality of second connection portions 1037. In FIG. 3, three second connection portions 1037 are used as an example to illustrate the structure of the supporting component 103. However, the disclosure is not limited thereto, and a quantity of the second connection portions 1037 may be 2, or may be 4 or more. In addition, in the present embodiment, the quantity of the first connection portions 1932 and the quantity of the second connection portions 1037 may be the same, or may be different. In the present embodiment, the plurality of first connection portions 1032 and the plurality of second connection portions 1037 may be disposed at equal intervals along the circumferential direction. However, the disclosure is not limited thereto. The plurality of first connection portions 1032 and the plurality of second connection portions 1037 may be disposed at non-equal intervals along the circumferential direction.

In the present embodiment, at least one of the plurality of second connection portions 1037 may be used for regulating a conductive wire. Therefore, interference between the conductive wire of the fan and other components can be avoided.

In the present embodiment, widths of the first connection portion 1032 and the second connection portion 1037 may be different. Setting the first connection portion 1032 and the second connection portion 1037 to have different widths can reduce the weight of the fan while ensuring the strength of the fan. As shown in FIG. 3, a width of the first connection portion 1032 may be set to be greater than a width of the second connection portion 1037. However, the disclosure is not limited thereto, and the width of the first connection portion 1032 may be set to be less than the width of the second connection portion 1037, or the width of the first connection portion 1032 may be the same as the width of the second connection portion 1037.

In the present embodiment, as shown in FIG. 3, the supporting component 103 may alternatively have an annular portion 1038 connected to an outer circumferential portion of the plurality of first connection portions 1032, and a radial width of the annular portion 1038 is less than an axial thickness. In other words, the annular portion 1038 may be set to a shape that is narrow in the radial direction and thick in the axial direction. Setting the annular portion 1038 in the supporting component 103 can further improve the strength of the supporting component 103. Setting the radial width of the annular portion 1038 to be less than the axial thickness can further reduce the weight of the fan while ensuring the strength of the supporting component 103. However, the disclosure is not limited thereto. The annular portion 1038 may alternatively be in other shapes.

FIG. 10 is a cross-sectional view of the fan 100 according to Embodiment 1 of the disclosure. As shown in FIG. 10, a surface (for example, a lower surface of the mounting portion 1033 shown in FIG. 10) on an axial side of the mounting portion 1033 is located in a position closer to the axial side (a lower side shown in FIG. 10) than a surface (for example, a lower surface of the base 1031 shown in FIG. 10) on an axial side of the base 1031. Using the foregoing structure enables a miss match to be formed between the mounting portion 1033 and the base 1031. Therefore, the vibration of the motor 102 can be prevented from being transmitted from the base 1031 to a body (or a main body) of the fan 100.

In the present embodiment, as shown in FIG. 10, the fan may further include the vibration-proof component 104.

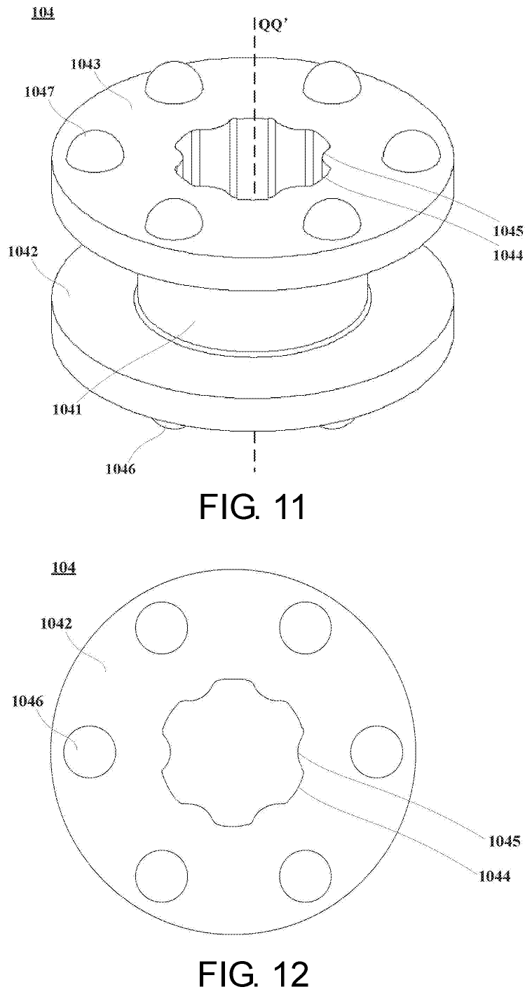

FIG. 11 is a schematic diagram of the vibration-proof component 104 according to Embodiment 1 of the disclosure. As shown in FIG. 10 and FIG. 11, the vibration-proof component 104 may include: a cylindrical portion 1041 extending along the axial direction (an up-and-down direction shown in FIG. 10 and FIG. 11), a first disk portion 1042 extending from an end portion on an axial side (a downward direction shown in FIG. 10 and FIG. 11) of the cylindrical portion 1041 to a radial outer side, and a second disk portion 1043 extending from an end portion on the other axial side (an upward direction shown in FIG. 10 and FIG. 11) of the cylindrical portion 1041 to the radial outer side.

In the present embodiment, the vibration-proof component 104 may be made of any material and, for example, the vibration-proof component 104 may be made of an elastic rubber material. In the process of mounting the vibration-proof component 104 into the mounting portion 103, as shown in FIG. 4 and FIG. 5, by applying a force in a direction shown by the arrow A in the figure onto the vibration-proof component 104, the vibration-proof component 104 is mounted into the mounting portion 103 through the opening portion 1036 of the mounting portion 103.

In the present embodiment, an external circumferential wall of the cylindrical portion 1041 of the vibration-proof component 104 is in contact with the first claw portion 1034 and the second claw portion 1035 of the mounting portion 103, wherein the first disk portion 1042 of the vibration-proof component 104 is located on the axial side (the lower side in FIG. 10) of the mounting portion 103, and the second disk portion 1043 is located on the other axial side (the upper side in FIG. 10) of the mounting portion 103. Therefore, the first disk portion 1042 and the second disk portion 1043 may be in contact with other components, so as to absorb the vibration generated when the motor 102 works, and reduce impact of vibration of other components on the fan 100.

In the present embodiment, a length of an outer diameter of the first disk portion 1042 and a length of an outer diameter of the second disk portion 1043 are each greater than the maximum inner diameter (a length X shown in FIG. 4 and FIG. 5) of the mounting portion 103. Therefore, the vibration-proof component 104 can be prevented from slipping and dropping from the mounting portion 103.

In the present embodiment, as shown in FIG. 11, a surface on a radial inner side of the cylindrical portion 1041 is in a convex and concave shape, wherein concave portions 1044 and convex portions 1045 alternately arranged in the circumferential direction are disposed on the surface with a center line QQ′ of the cylindrical portion 1041 as a center. In an implementation, the cylindrical portion 1041 may be provided with a stud. Setting the surface on the inner side of the cylindrical portion 1041 to be in the convex and concave shape can enable the stud to be easily mounted, and the stud can be reliably mounted in the cylindrical portion 1041 without requiring the surface on the radial inner side of the cylindrical portion 1041 to have relatively high accuracy. However, the disclosure is not limited thereto. The surface on the radial inner side of the cylindrical portion 1041 may alternatively be in other shapes.

In the present embodiment, any quantity of concave portions 1044 and convex portions 1045 may be disposed on the surface on the radial inner side of the cylindrical portion 1041. For example, as shown in FIG. 11, six concave portions 1044 and six convex portions 1045 may be disposed on the surface on the radial inner side of the cylindrical portion 1041.

In the present embodiment, as shown in FIG. 11, a surface on the axial side (a lower side in FIG. 11) of the first disk portion 1042 is provided with a first protruding portion 1046 protruding towards the axial side, or a surface on the other axial side (an upper side in FIG. 11) of the second disk portion 1043 is provided with a second protruding portion 1047 protruding towards the other axial side, or the first protruding portion 1046 and the second protruding portion 1047 are disposed on the first disk portion 1042 and the second disk portion 1043 respectively. This can further improve a vibration-proof effect.

In the present embodiment, the first protruding portion 1046 and the second protruding portion 1047 may be in any shape. For example, as shown in FIG. 10 and FIG. 11, the first protruding portion 1046 and the second protruding portion 1047 are in a spherical shape. In addition, the first protruding portion 1046 and the second protruding portion 1047 may be in other shapes. The first protruding portion 1046 and the second protruding portion 1047 may be in the same shape, or may be in different shapes.

In an implementation, when the first protruding portion 1046 and the second protruding portion 1047 are disposed on the first disk portion 1042 and the second disk portion 1043 respectively, a quantity of first protruding portions 1046 and a quantity of second protruding portion 1047 may be the same, or may be different, and a position of the first protruding portion 1046 in the axial direction and a position of the second protruding portion 1047 in the axial direction may be the same, or may be different.

FIG. 12 is a top view of the vibration-proof component 104 according to Embodiment 1 of the disclosure. In the present embodiment, as shown in FIG. 12, a quantity of first protruding portions 1046 and a quantity of convex portions 1045 are the same, or a quantity of second protruding portions 1047 and a quantity of convex portions 1045 are the same, or both a quantity of first protruding portions 1046 and a quantity of second protruding portions 1047 are the same as a quantity of convex portions 1045. Therefore, the first protruding portion 1046 and/or the second protruding portion 1047 can be conveniently disposed.

In an implementation, the first protruding portion 1046 and/or the second protruding portion 1047 may be disposed in any position of the first disk portion 1042 and/or the second disk portion 1043. For example, as shown in FIG. 12, the first protruding portion 1046 and/or the second protruding portion 1047 may be disposed in a position opposite to the convex portion 1045 in the radial direction. Because the vibration-proof component 1045 has a relatively large width in the radial direction in a position of the convex portion 1045, the strength of the vibration-proof component 104 can be improved by disposing the first protruding portion 1046 and/or the second protruding portion 1047 in the position opposite to the convex portion 1045 in the radial direction, thereby further improving the vibration-proof effect. Alternatively, the first protruding portion 1046 and/or the second protruding portion 1047 may be disposed in a position opposite to the concave portion 1044 in the radial direction. Alternatively, the first protruding portion 1046 and/or the second protruding portion 1047 may be disposed in a position staggered with the convex portion 1045 and the concave portion 1044 in the radial direction.

In the present embodiment, the first gap on the radial outer side of the opening portion of the mounting portion is made greater than the second gap on the radial inner side of the opening portion, so that the vibration-proof component can be easily mounted into the mounting portion through the opening portion, and further working hours of the operation of mounting the vibration-proof component can be reduced, thereby improving production efficiency.

Features of the above-described preferred embodiments and the modifications thereof may be combined appropriately as long as no conflict arises. While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A fan, comprising:
an impeller, rotating with a rotation axis as a center;
a motor, disposed on an axial side of the impeller to drive the impeller to rotate; and
a supporting component, disposed on an axial side of the motor to support the motor, wherein
the supporting component comprises:
a base, disposed on the axial side of the motor;
a plurality of first connection portions, extending from a partial area of a side wall of the base to a radial outer side; and
a plurality of mounting portions, disposed on an end portion on the radial outer side of the first connection portion and configured in a position closer to the radial outer side than the impeller, wherein the mounting portion comprises a first claw portion and a second claw portion arranged along a circumferential direction,
wherein
an opening portion into which a vibration-proof component is inserted is provided between an end portion of the first claw portion and an end portion of the second claw portion, and a first gap on the radial outer side of the opening portion is greater than a second gap on a radial inner side of the opening portion.

2. The fan according to claim 1, wherein a gap of the opening portion is set to be gradually increased along a radial direction from a second position in which the second gap is located to a first position in which the first gap is located, wherein
the first position is a radially outermost position of the opening portion, the second position is a radially innermost position of the opening portion, or the second position is an intermediate position between the radially innermost position and the radially outermost position of the opening portion.

3. The fan according to claim 1, wherein
the end portion of the first claw portion and the end portion of the second claw portion are in an arc shape, a polygonal shape, a slash shape, a shape combining an arc shape with a polygonal shape, or a shape combining an arc shape with a straight line.

4. The fan according to claim 1, wherein
the end portion of the first claw portion and the end portion of the second claw portion are in a shape that is symmetric relative to a radial direction.

5. The fan according to claim 1, wherein
a maximum inner diameter of the mounting portion is equal to or greater than a minimum gap of the opening portion by greater than one time, and less than or equal to five times.

6. The fan according to claim 1, wherein
a maximum gap of the opening portion is greater than a minimum gap of the opening portion by greater than one time, and less than or equal to three times.

7. The fan according to claim 1, wherein the supporting component further comprises:
a plurality of second connection portions, extending from a partial area of the side wall of the base to the radial outer side, wherein
the plurality of first connection portions and the plurality of second connection portions are disposed at equal intervals along the circumferential direction.

8. The fan according to claim 7, wherein
widths of the first connection portion and the second connection portion are different.

9. The fan according to claim 1, wherein
the supporting component further comprises an annular portion connected to an outer circumferential portion of the plurality of first connection portions, and
a radial width of the annular portion is less than an axial thickness.

10. The fan according to claim 1, wherein
a surface on an axial side of the mounting portion is located in a position closer to the axial side than a surface on an axial side of the base.

11. The fan according to claim 1, wherein
the fan further comprises the vibration-proof component, and
the vibration-proof component comprises:
a cylindrical portion extending along an axial direction, a first disk portion extending from an end portion on an axial side of the cylindrical portion to the radial outer side, and a second disk portion extending from an end portion on an other axial side of the cylindrical portion to the radial outer side.

12. The fan according to claim 11, wherein
a surface on a radial inner side of the cylindrical portion is in a convex and concave shape, wherein concave portions and convex portions alternately arranged in the circumferential direction are disposed on the surface with a center line of the cylindrical portion as a center.

13. The fan according to claim 12, wherein
a surface on the axial side of the first disk portion is provided with a first protruding portion protruding towards the axial side, and/or
a surface on the other axial side of the second disk portion is provided with a second protruding portion protruding towards the other axial side.

14. The fan according to claim 13, wherein
a quantity of the first protruding portions and/or a quantity of the second protruding portions is the same as a quantity of the convex portions.
